(19) United States
(12) Patent Application Publication
(10) Pub. No.: US 2002/0087965 A1
(43) Pub. Date: Jul. 4, 2002

(54) Method for producing a computer

(76) Inventor: Jiann-Shiun Lin, Taipei (TW)

Correspondence Address: SHAW PITTMAN, 1650 TYSONS BOULEVARD, MCLEAN, VA, 22102, US

(21) Appl. No.: 09/912,394

(22) Filed: Jul. 26, 2001

(30) Foreign Application Priority Data
Dec. 27, 2000 (TW) 089128088

(51) Int. Cl. G06F 9/455

(52) U.S. Cl. 717/174

(57) ABSTRACT

The method comprises the following steps. First, an order receiving system of a computer company receives an order from a client. The order comprises a hardware component list required and a software component list both required by the client. A hardware component list transmitting system of the computer company transmits the hardware component list to a computer manufacturer. By using the pre-load software mechanism, the computer company pre-loads the software components itemized in the software component list in a storage device. The computer manufacturer assembles the hardware components itemized in the hardware component list. The computer manufacturer delivers the assembled hardware components to the client. The computer company delivers the pre-loaded storage device to the client. When the client receives the pre-loaded storage device and the assembled hardware components, the client installs the storage device in the assembled hardware components to complete the computer.

### REFERENCE TO RELATED APPLICATION

The present application claims priority to Taiwan application No. 089128088, entitled “Method for Producing A Computer,” filed on Dec. 27, 2000.

### BACKGROUND OF THE INVENTION

1. Field of the Invention

The present invention relates to a method for producing a computer. More particularly, the present invention relates to a method for producing a computer. According to the invention, a computer manufacturer and a computer company separately delivers assembled hardware components and a pre-loaded storage device to a client, and the client installs the pre-loaded storage device in the assembled hardware components to complete a computer.

2. Description of the Related Art

Under the development of global labor-division in the computer industry, most computer companies outsource computers hardware components assembly to computer manufacturers. When the computer manufacturers complete the hardware components assembly, the assembled hardware components are delivered to the computer companies. Thereafter the computer companies install storage devices, which have been pre-loaded with software components in the assembled hardware components to complete a computer. To pre-load software components in a storage device involves critical and confidential contents concerning technology and business. As a result, computer companies prefer to increase the cost of computer production rather than disclose the trade secret to the computer manufacturers.

FIG. 1 is a perspective diagram of a prior art computer production system 10. FIG. 2 is a production flow chart of the computer production system 10 in FIG. 1. Some computer companies, such as Dell Inc., adopt a BTO (Build to Order) process, a process where the manufacturing is based on the order received. The computer production system 10 comprises an order receiving system 12, a hardware component list transmitting system 14, a pre-load software mechanism 16, and a computer assembly mechanism 18.

In step 201, the order receiving system 12 receives an order from a client. The order comprises a hardware component list required by the client, and a software component list for designating the software required by the client.

In step 202, the hardware component list transmitting system 14 transmits the hardware component list to a computer manufacturer 20.

In step 203, by using the pre-load software mechanism 16, the computer company pre-loads the software components itemized in the software component list in a storage device, such as a hard disk.

In step 204, the computer manufacturer 20 assembles the hardware components itemized in the hardware component list.

In step 205, the computer manufacturer 20 delivers the assembled hardware components to the computer company.

In step 206, the computer company installs the pre-loaded storage device in the assembled hardware components to complete the computer using the computer assembly mechanism 18.

In step 207, the computer company delivers the completed computer to the client.

In this production process, the computer manufacturer has to deliver the assembled hardware components to the computer company, and the computer company installs the pre-loaded storage device in the assembled hardware components. After the installation, the computer company delivers the completed computer to the client. It costs a great of money to deliver the assembled hardware components from the computer manufacturer to the computer company, and it also costs a great of money to deliver the completed computer from the computer company to the client. To avoid critical contents concerning technology and business being disclosed to potential competitors, the computer company spends a lot of money on shipping the assembled hardware components and the completed computer, which greatly increase the cost of computer production.

FIG. 3 is a perspective diagram of another prior art computer production system 30. FIG. 4 is a production flow chart of the computer production system 30 in FIG. 3. Some computer companies, such as IBM Inc., sell computers to clients via distributors. The computer production system 30 comprises a computer component list decision mechanism 32, a hardware component list transmitting system 34, a pre-load software mechanism 36, and a computer assembly mechanism 38.

In step 401, the computer company generates a computer component list by the computer component list decision mechanism 32. The computer component list comprises a hardware component list for designating the hardware components of a computer, and a software component list for designating the software components of the computer.

In step 402, the hardware component list transmitting system 34 transmits the hardware component list to a computer manufacturer.

In step 403, by using the pre-load software mechanism 36, the computer company pre-loads the software components designated in the software component list in a storage device, such as a hard disk.

In step 404, the computer manufacturer assembles the hardware components itemized in the hardware component list.

In step 405, the computer manufacturer delivers the assembled hardware components to the computer company.

In step 406, by the computer assembly mechanism 38, the computer company installs the pre-loaded storage device in the assembled hardware components to complete the computer.

In step 407, the computer company delivers the completed computer to a distributor 42, and the computer is sold to a client 44 via the distributor 42.

Similarly, in this production process, the computer manufacturer has to deliver the assembled hardware components to the computer company, and the computer company installs the pre-loaded storage device in the assembled hardware components. After the installation, the computer company delivers the completed computer to the distributor. It costs a great of money to deliver the assembled hardware components from the computer manufacturer to the computer company, and it also costs a great of money to deliver the completed computer from the computer company to the distributor. To avoid critical contents concerning technology and business being disclosed to potential competitors, the computer company spends a lot of money on shipping the assembled hardware components and the completed computer so as to greatly increase the cost of computer production.

### SUMMARY OF THE INVENTION

It is therefore a primary objective of the present invention to provide a method for producing a computer to solve the above-mentioned problems. In this method, the computer manufacturer and the computer company separately delivers assembled hardware components and a pre-loaded storage device to a client, and the client installs the pre-loaded storage device in the assembled hardware components to complete the computer.

In a preferred embodiment, the present invention provides a method for producing a computer. The method comprises the following steps. An order receiving system of a computer company receives an order from a client. The order comprises a hardware component list required by the client, and a software component list for designating the software required by the client. Then, a hardware component list transmitting system of the computer company transmits the hardware component list to a computer manufacturer. By using the pre-load software mechanism, the computer company pre-loads the software components itemized in the software component list in a storage device, such as a hard disk. And the computer manufacturer assembles the hardware components itemized in the hardware component list. Next, the computer manufacturer delivers the assembled hardware components to the client. At the same time, the computer company delivers the pre-loaded storage device to the client. When the client receives the pre-loaded storage device and the assembled hardware components, the client are allowed to install the storage device in the assembled hardware components to complete the computer.

It is an advantage of the present invention that not only the unnecessary shipping cost is avoided, but also the computer company can waive the labor cost from installing the pre-loaded storage device in the assembled hardware components. Those greatly reduce the cost of the computer production. Furthermore, the computer company is free from worrying about that the critical contents of technology and business may be disclosed to the potential competitors through conventional process.

These and other objectives of the present invention will no doubt become obvious to those of ordinary skill in the art after having read the following detailed description of the preferred embodiment, which is illustrated in the various figures and drawings.

### BRIEF DESCRIPTION OF DRAWINGS

The following detailed description, given by way of examples and not intended to limit the invention to the embodiments described herein, will best be understood in conjunction with the accompanying drawings, in which:

FIG. 1 is a perspective diagram of a prior art computer production system;

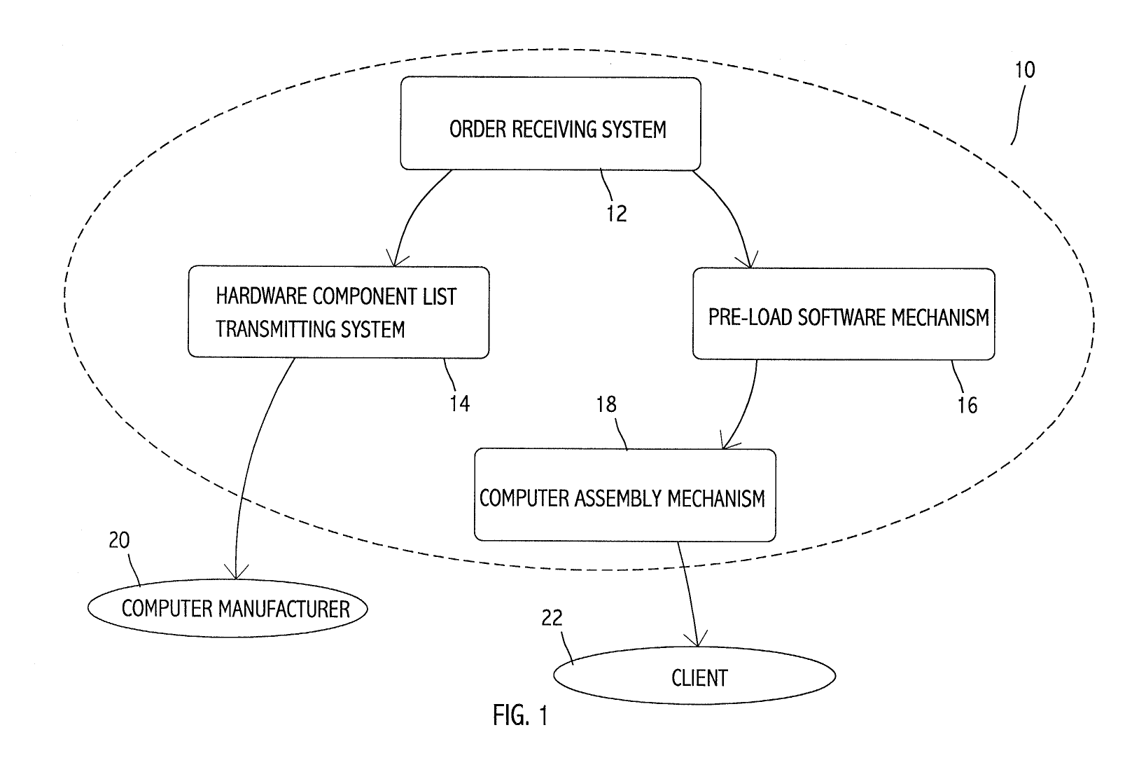

FIG. 2 is a production flow chart of the computer production system in FIG.1;

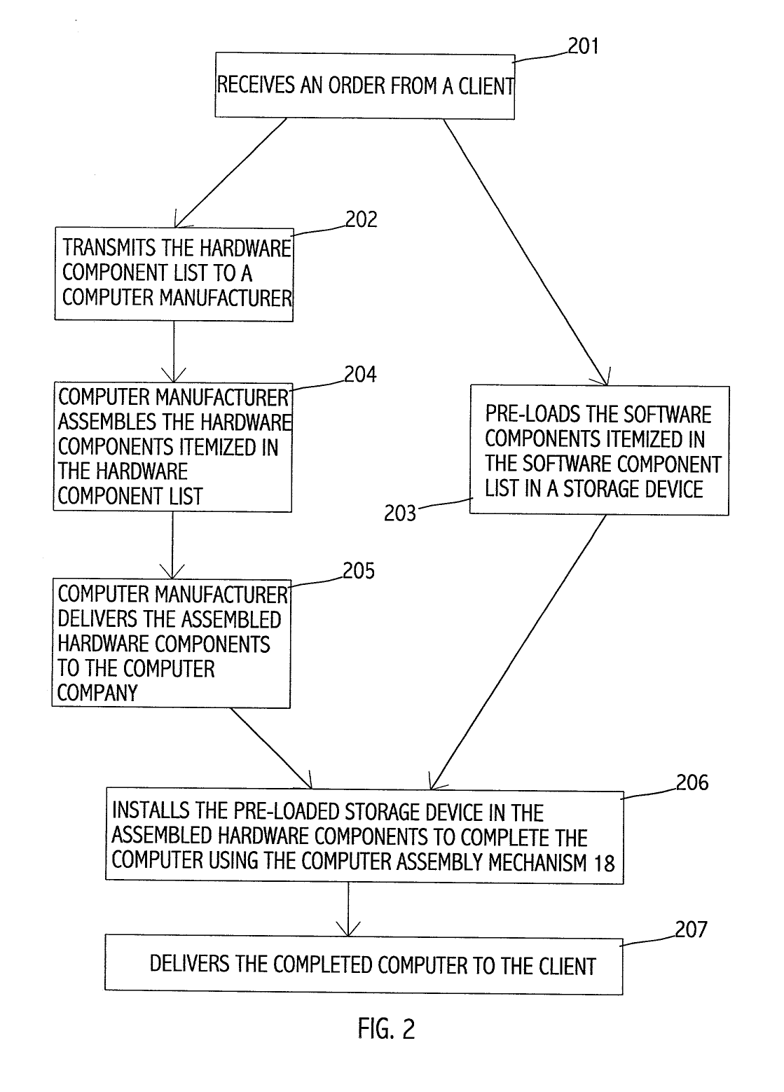

FIG. 3 is a perspective diagram of another prior art computer production system;

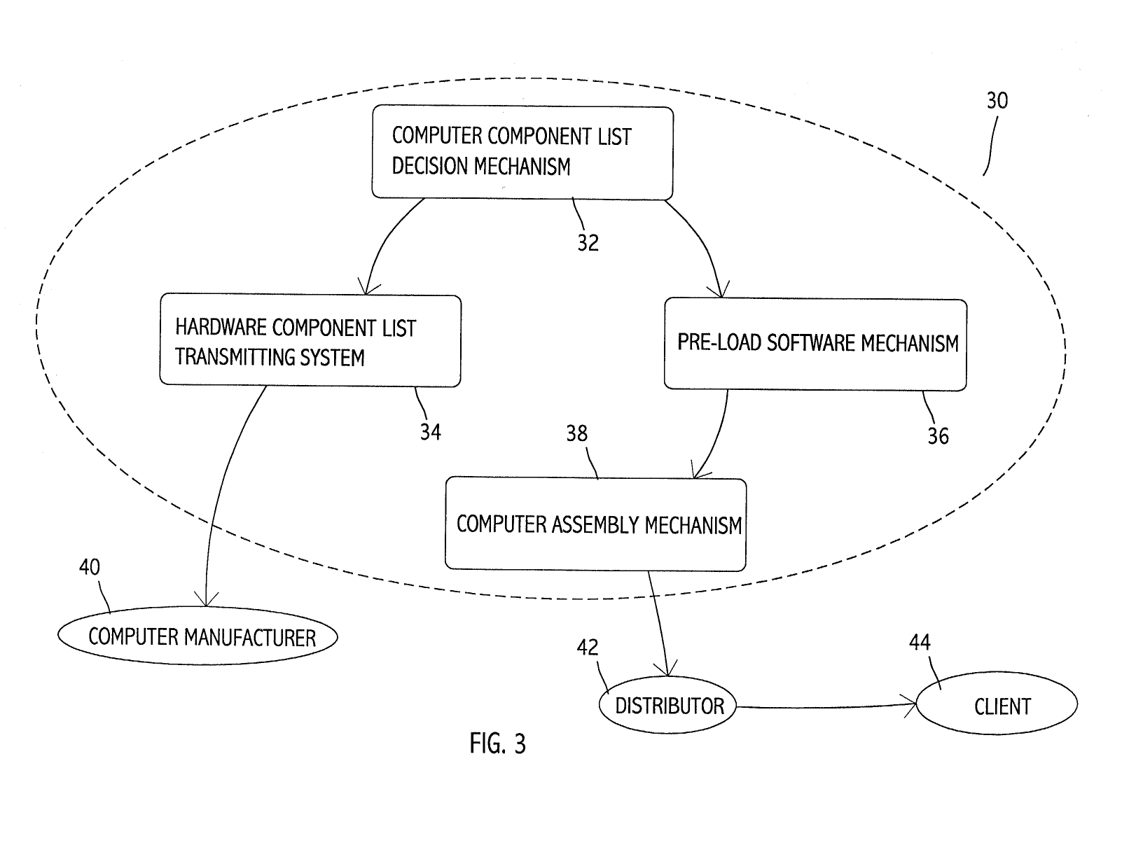

FIG. 4 is a production flow chart of the computer production system in FIG. 3;

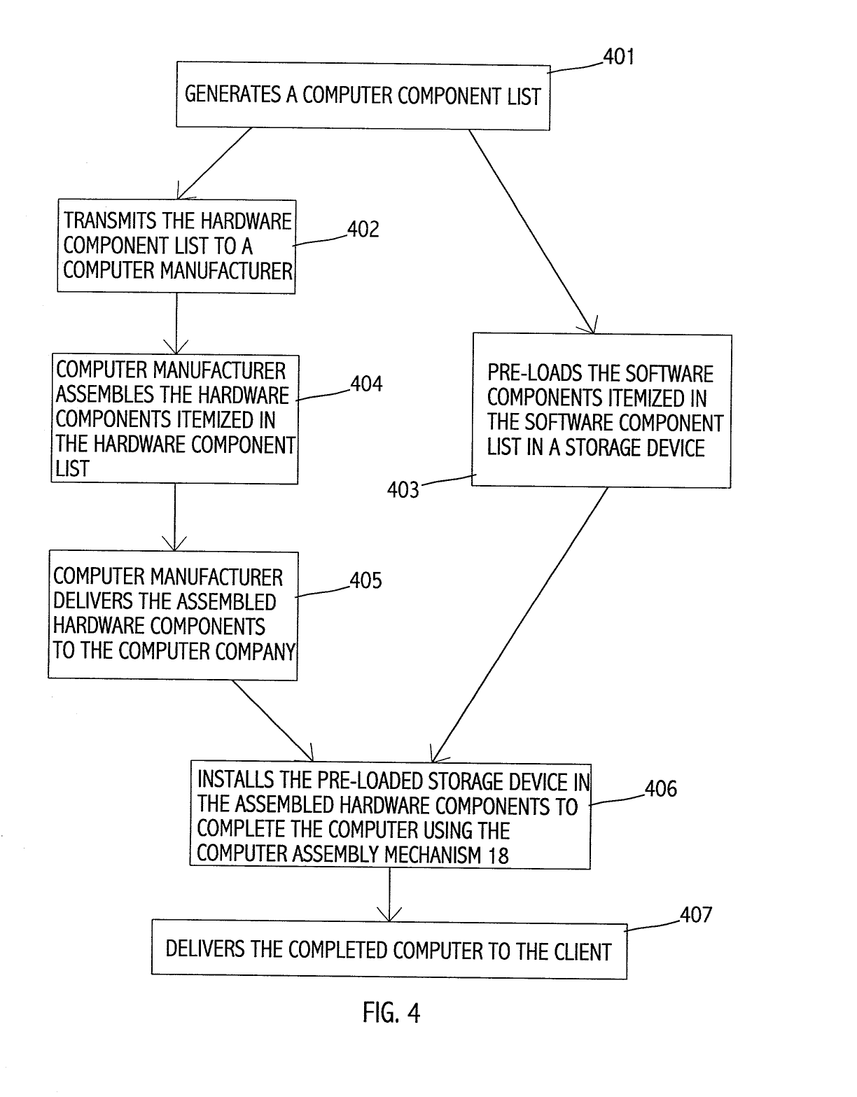

FIG. 5 is a perspective diagram of a computer production system according to the present invention;

FIG. 6 is a production flow chart of the computer production system in FIG. 5;

FIG. 7 is a perspective diagram of another computer production system according to the present invention; and

FIG. 8 is a production flow chart of the computer production system in FIG. 7.

### DETAILED DESCRIPTION OF THE INVENTION

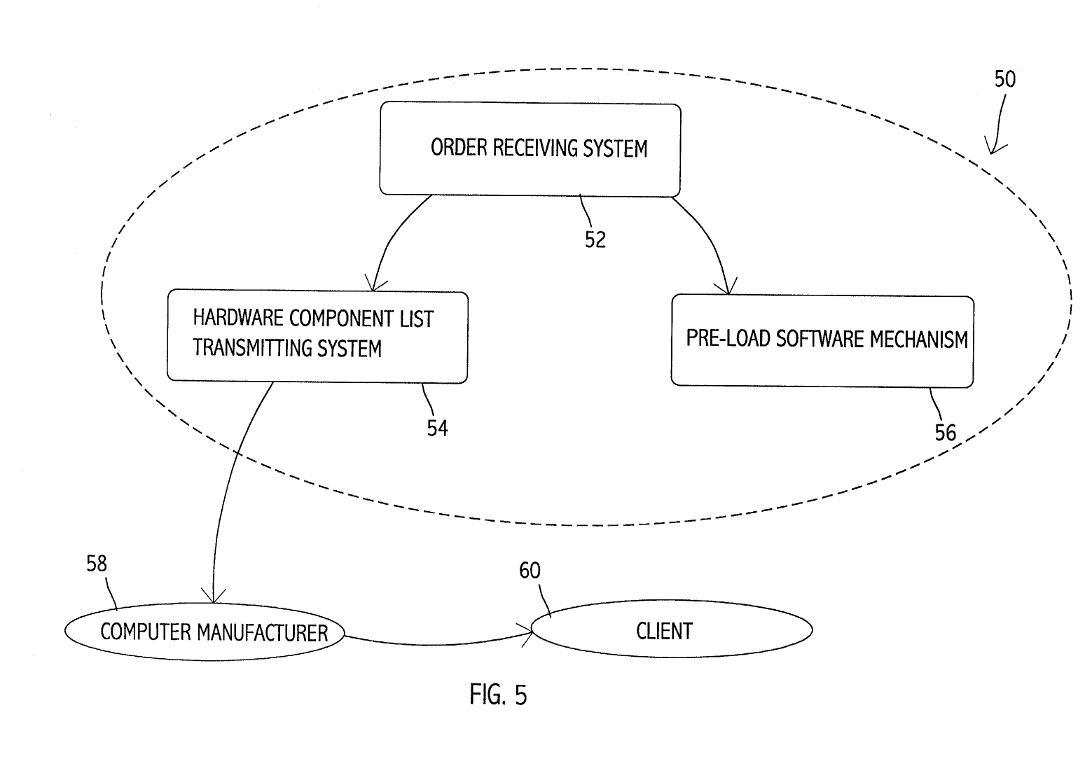

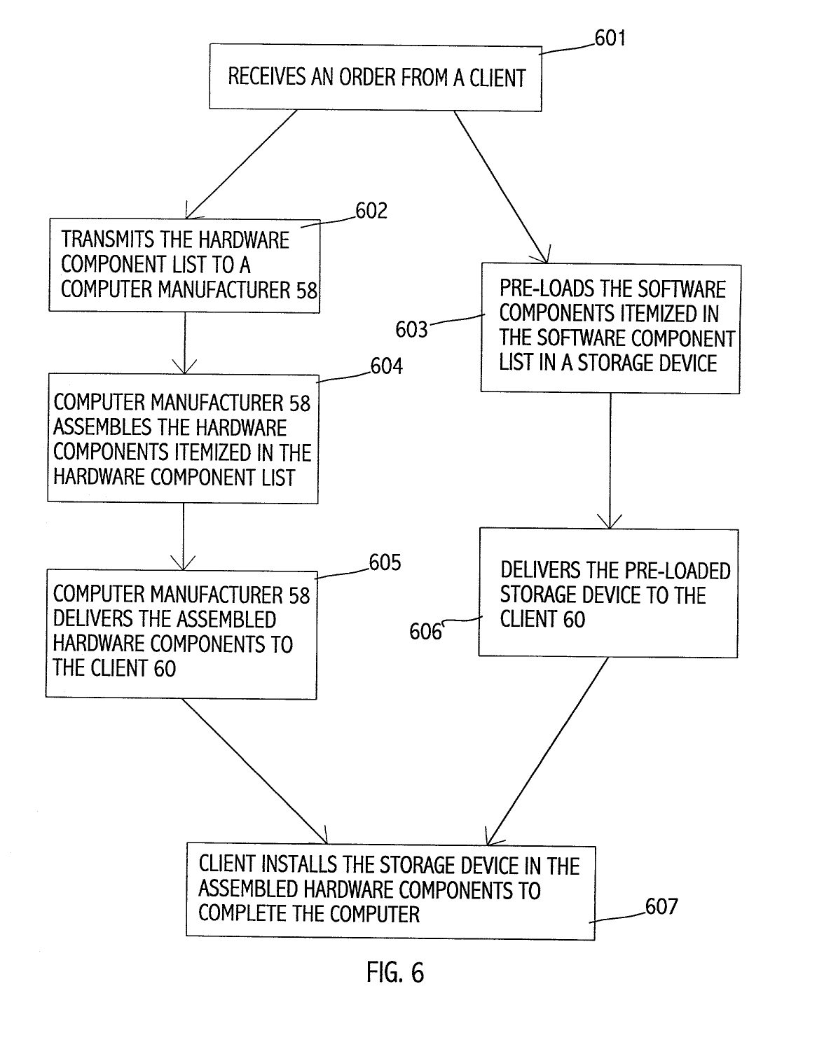

Referring FIG. 5 and FIG. 6. FIG. 5 is a perspective diagram of a computer production system 50 according to the present invention. FIG. 6 is a production flow chart of the computer production system 50 in FIG. 5. The computer production system 50 comprises an order receiving system 52, a hardware component list transmitting system 54, and a pre-load software mechanism 56.

In step 601, the order receiving system 52 receives an order from a client. The order comprises a hardware component list required by the client, and a software component list for designating the software required by the client.

In step 602, the hardware component list transmitting system 54 transmits the hardware component list to a computer manufacturer 58.

In step 603, by using the pre-load software mechanism 56, a computer company pre-loads the software components itemized in the software component list in a storage device, such as a hard disk.

In step 604, the computer manufacturer 58 assembles the hardware components itemized in the hardware component list.

In step 605, the computer manufacturer 58 delivers the assembled hardware components to the client 60.

In step 606, the computer company delivers the pre-loaded storage device to the client 60. When the client 60 receives the pre-loaded storage device and the assembled hardware components, the client installs the storage device in the assembled hardware components to complete the computer as shown in step 607.

Furthermore, the order comprises a delivery time list for designating a preferred delivery time by the client. Not only the hardware component list but also the delivery time list is transmitted to the computer manufacturer. As a result, the computer manufacturer delivers the assembled hardware components to the client according to the delivery time list. In the same way, the computer company delivers the pre-loaded storage device to the client according to the delivery time list. When the client receives the pre-loaded storage device and the assembled hardware components on the preferred time, the client installs the storage device in the assembled hardware components to complete the computer.

In this production process, the computer manufacturer delivers the assembled hardware components to the client instead of the computer company. As a result, this production method avoids unnecessary cost of shipping so as to greatly reduce the cost of computer production. Furthermore, the computer company is free from worrying about that the critical contents of technology and business may be disclosed to the potential competitors.

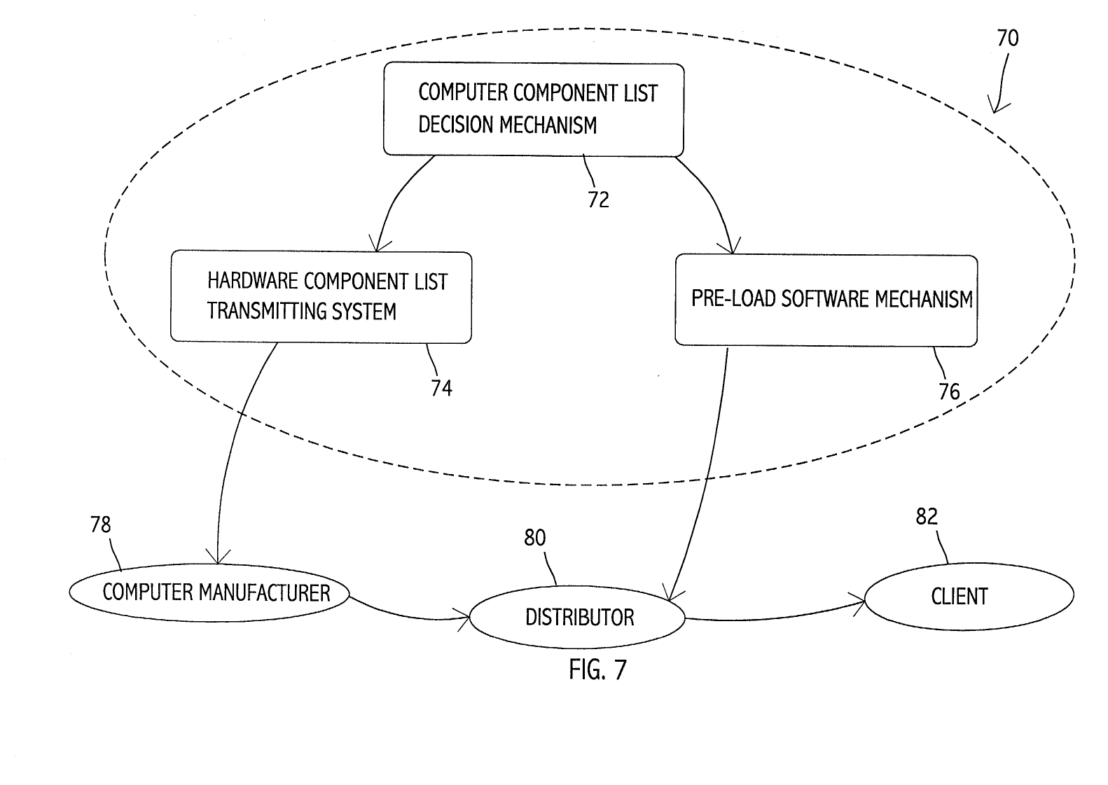

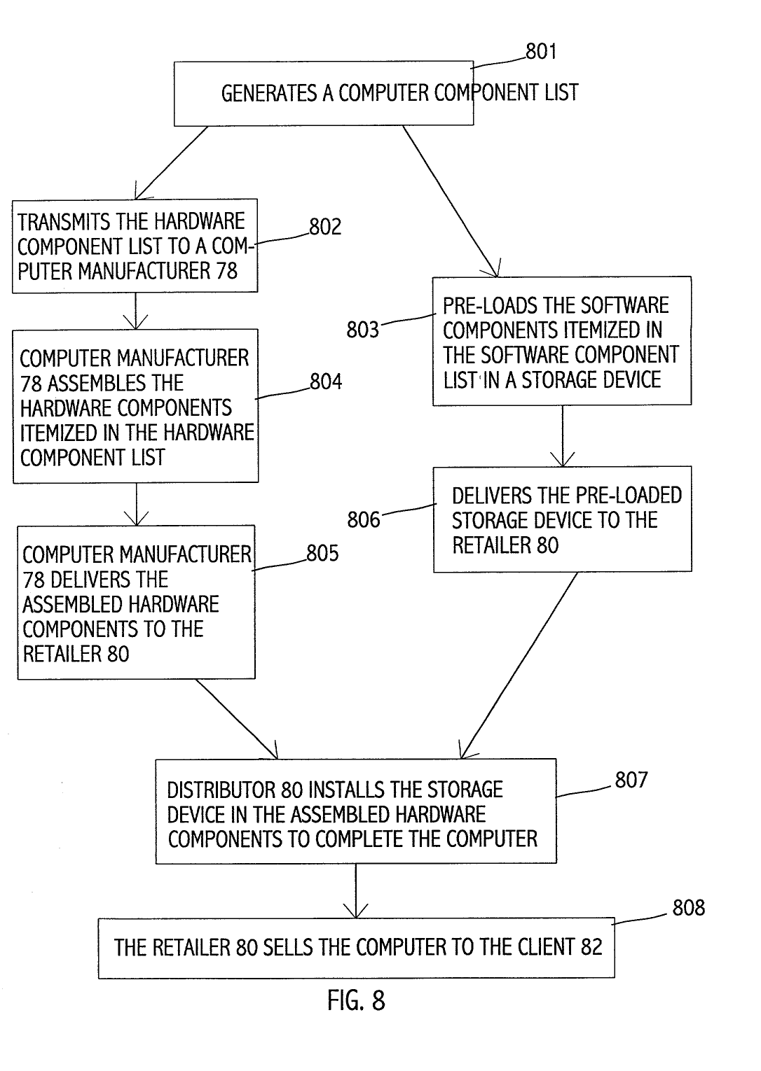

FIG. 7 is a perspective diagram of another computer production system 70 according to the present invention. FIG. 8 is a production flow chart of the computer production system 70 in FIG. 7. The computer production system 70 comprises a computer component list decision mechanism 72, a hardware component list transmitting system 74, and a pre-load software mechanism 76.

In step 801, by the computer component list decision mechanism 72, the computer company generates a computer component list. The computer component list comprises a hardware component list for designating the hardware components of a computer, and a software component list for designating the software components of the computer.

In step 802, the hardware component list transmitting system 74 transmits the hardware component list to a computer manufacturer 78.

In step 803, by using the pre-load software mechanism 76, the computer company pre-loads the software components designated in the software component list in a storage device, such as a hard disk.

In step 804, the computer manufacturer 78 assembles the hardware components designated in the hardware component list.

In step 805, the computer manufacturer 78 delivers the assembled hardware components to the distributor 80.

In step 806, the computer company delivers the pre-loaded storage device to the distributor 80. When the distributor 80 receives the pre-loaded storage device and the assembled hardware components, the distributor 80 installs the storage device in the assembled hardware components to complete the computer as shown in step 807.

In step 808, the distributor 80 sells the computer to the client 82.

In this embodiment, after the computer being assembled, the distributor sells the computer to the client. The distributor can also sell the pre-loaded storage device and the assembled hardware components to the client separately, and then the client installs the storage device in the assembled hardware components to complete the computer.

Similarly, in this production process, the computer manufacturer delivers the assembled hardware components to the distributor instead of the computer company. As a result, this production method avoids unnecessary cost of shipping so as to greatly reduce the cost of computer production. Furthermore, the computer company has not to worry about that the critical contents of technology and business may be disclosed to the potential competitors.

Compared with the prior art, in the method of producing a computer according to the present invention, the computer manufacturer and the computer company separately delivers assembled hardware components and a pre-loaded storage device to the client or the distributor, and the client or the distributor installs the pre-loaded storage device in the assembled hardware components to complete the computer. In this way, the computer manufacturer delivers the assembled hardware components to the client or the distributor instead of the computer company. Not only the unnecessary shipping cost is avoided, but also the computer company can waive the labor cost from installing the pre-loaded storage device in the assembled hardware components. This greatly reduces the cost of the computer production. Furthermore, the computer company is free from worrying about that the critical contents of technology and business may be disclosed to the potential competitors.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments as may fall within the scope of the invention defined by the following claims and their equivalents.

What is claimed is:

1. A method for producing a computer, comprising:
receiving an order from a client, the order being used for ordering the computer, the order comprising a hardware component list and a software component list;
transmitting the hardware component list to a computer manufacturer, and the computer manufacturer assembling hardware components itemized in the hardware component list; and
pre-loading software components itemized in the software component list in a storage device.

2. The method of claim 1 further comprising the step of delivering the pre-loaded storage device to the client.

3. The method of claim 2 wherein the computer manufacturer delivers the assembled hardware components to the client.

4. The method of claim 3 wherein when the client receives the pre-loaded storage device and the assembled hardware components, the client installs the storage device in the assembled hardware components to complete the computer.

5. The method of claim 1 wherein the order further comprises a delivery time list, and the pre-loaded storage device is delivered to the client according to the delivery time list.

6. The method of claim 5 further comprising the step of transmitting the delivery time list to the computer manufacturer, and the computer manufacturer delivering the assembled hardware components to the client according to the delivery time list.

7. The method of claim 6 wherein when the client receives the pre-loaded storage device and the assembled hardware components, the client installs the storage device in the assembled hardware components to complete the computer.

8. The method of claim 1 wherein the storage device is a hard disk.

9. A method for producing a computer, comprising:
receiving a hardware component list from a computer company, the computer company generating the hardware component list according a client's order for the computer; and
assembling hardware components itemized in the hardware component list.

10. The method of claim 9 wherein the order comprises a hardware component list and a software component list, and the computer company pre-loads software components itemized in the software component list in a storage device.

11. The method of claim 10 wherein the computer company delivers the pre-loaded storage device to the client.

12. The method of claim 11 further comprising the step of delivering the assembled hardware components to the client.

13. The method of claim 12 wherein when the client receives the pre-loaded storage device and the assembled hardware components, the client installs the storage device in the assembled hardware components to complete the computer.

14. The method of claim 10 wherein the order further comprises a delivery time list, and the computer company delivers the pre-loaded storage device to the client according to the delivery time list.

15. The method of claim 14 further comprising the step of receiving the delivery time list from the computer company, and delivering the assembled hardware components to the client according to the delivery time list.

16. The method of claim 15 wherein when the client receives the pre-loaded storage device and the assembled hardware components, the client installs the storage device in the assembled hardware components to complete the computer.

17. The method of claim 10 wherein the storage device is a hard disk.

18. A method for producing a computer, comprising:
generating a computer component list, the computer component list comprising a hardware component list and a software component list;
transmitting the hardware component list to a computer manufacturer, and the computer manufacturer assembling hardware components itemized in the hardware component list; and
pre-loading software components itemized in the software component list in a storage device.

19. The method of claim 18 further comprising the step of delivering the pre-loaded storage device to a distributor

20. The method of claim 19 wherein the computer manufacturer delivers the assembled hardware components to the distributor.

21. The method of claim 20 wherein when the distributor receives the pre-loaded storage device and the assembled hardware components, the distributor installs the storage device in the assembled hardware components to complete the computer.

22. The method of claim 20 wherein the distributor sells the storage device to a client.

23. The method of claim 22 wherein the distributor sells the assembled hardware components to the client.

24. The method of claim 23 wherein the client installs the storage device in the assembled hardware components to complete the computer.

25. The method of claim 18 wherein the storage device is a hard disk.

26. A method for producing a computer, comprising:
receiving a hardware component list from a computer company, the computer company generating a computer component list comprising the hardware component list; and
assembling hardware components itemized in the hardware component list.

27. The method of claim 26 wherein the computer component list further comprises a software component list, and the computer company pre-loads software components itemized in the software component list in a storage device.

28. The method of claim 27 wherein the computer company delivers the pre-loaded storage device to a distributor.

29. The method of claim 28 further comprising the step of delivering the assembled hardware components to the distributor.

30.The method of claim 29 wherein when the distributor receives the pre-loaded storage device and the assembled hardware components, the distributor installs the storage device in the assembled hardware components to complete the computer.

31. The method of claim 29 wherein the distributor sells the pre-loaded storage device to a client.

32. The method of claim 31 wherein the distributor sells the assembled hardware components to the client.

33. The method of claim 32 wherein the client installs the storage device in the assembled hardware components to complete the computer.

34. The method of claim 26 wherein the storage device is a hard disk.
